(19) United States
(12) Patent Application Publication
(10) Pub. No.: US 2014/0172376 A1
(43) Pub. Date: Jun. 19, 2014

(54) Data Center Designer (DCD) for a Virtual Data Center

(71) Applicants: Achim Weiss, Berlin (DE); Conrad N. Wood, Berlin (DE)

(72) Inventors: Achim Weiss, Berlin (DE); Conrad N. Wood, Berlin (DE)

(73) Assignee: ProfitBricks, Inc., Cambridge, MA (US)

(21) Appl. No.: 13/835,013

(22) Filed: Mar. 15, 2013

Related U.S. Application Data
(60) Provisional application No. 61/739,683, filed on Dec. 19, 2012.

(51) Int. Cl. G06F 17/50

(52) U.S. Cl. CPC G06F 17/50
USPC 703/1

(57) ABSTRACT

A data center designer (DCD) includes a graphical user interface which allows a user to easily assemble a virtual data center having desired characteristics while at the same time allowing the user to retain a constant overview of their virtual data center. The DCD may also allow a user to implement the design in physical resources.

### CROSS REFERENCE TO RELATED APPLICATIONS

This application claims priority and benefit of U.S. Provisional Patent Application No. 61/739,683, filed Dec. 19, 2012, and U.S. Provisional Patent Application No. 61/739,925, filed Dec. 20, 2012, which are incorporated by reference here in their entireties.

### FIELD

The concepts described herein relate generally to data centers and more particularly to virtual data centers.

### BACKGROUND

A data center is a facility used to house computer systems and associated components, such as telecommunications and storage systems. It generally includes redundant or backup power supplies, redundant data communications connections, redundant storage devices, environmental controls (e.g., air conditioning, fire suppression) and security devices.

There is a trend to use IT virtualization technologies to replace or consolidate multiple data center equipment, such as servers. One method of consolidation may be referred to as virtualization, where front-end software interfaces provide users with access to back-end computing devices. The infrastructure implemented in the back-end may be transparent to the user and abstracted by the front-end interface. In other words, as long as the user receives the proper services through the virtual, front-end, the user may not need to understand how the back end implements those services. Virtualization technologies may also used to create virtual desktops, which can then be hosted in data centers and rented out on a subscription basis.

As is further known, one of the best ways to design and architect Internet environments is to use a large, blank whiteboard to outline, correct and improve a complete infrastructure design by drawing it with a writing implement.

Most cloud hosting Infrastructure as a Service (IaaS) providers require that a user convert these drawings into text tables of virtual servers and storage, before linking them—a cumbersome and error prone process. Furthermore, with each subsequent change, a user must select a row in the table and setup network connections, IPs and more. Some providers further require a user to replace an entire infrastructure.

### SUMMARY

in accordance with the concepts, systems and techniques described herein, a data center designer (DCD) is described. The DCD includes a ‘virtual whiteboard’ which facilitates user design of a virtual data center (VDC). The DCD allows a user to design a Virtual Data Center comprising servers, storage, load balancers, firewalls and associated networking. Once the Virtual Data Center is complete, a user simply activates the data center design with mouse-click.

With this particular arrangement, a data center designer (DCD) allows a user to easily put together their own data center with a graphical user interface while at the same time retaining a constant overview of their virtual data center.

Furthermore, the DCD provides the user having a permanent graphical overview of their entire Virtual Data Center. Since the user retains this overview of the structure at all times, data center management and changes are relatively easy thereby saving a user time and avoiding costly errors.

A graphical user interface DCD enables a user to set up their own virtual data center in a cloud using at least drag and drop servers, storage, and network connections.

When a user acquires (e.g. rents) a virtual data center, the DCD allows the user to equip the VDC exactly according to user requirements with servers, memory, load balancers, custom network topologies, and firewalls in the same manner as a traditional data center. However, in contrast to designing a physical hardware infrastructure, the DCD allows the user to design a virtual computing infrastructure that specifies and provides computing services desired by the user. Once the virtual infrastructure is designed, the system may implement the services by assign physical resources to provide the services. The physical resources may or may not be arranged in the same way as the virtual infrastructure, as will be discussed below. Thus, the user only pays for those resources actually assigned to the user and the user can optimize the VDC via the DCD to the user's current requirements at any point in time.

In accordance with a further aspect of the concepts described herein, a method for designing a virtual data center includes dragging and dropping virtual data center elements onto a virtual whiteboard and provide network connections between each of the elements. The DCD also facilitates provisioning and allocating the virtual data center based upon the configuration of the network illustrated on the virtual whiteboard to provide a virtual data center.

With this particular arrangement, a simple and quick way to generate a virtual data center is provided.

### BRIEF DESCRIPTION OF THE DRAWINGS

The foregoing features of this invention, as well as the invention itself, may be more fully understood from the following description of the drawings in which:

FIG. 1 is a block diagram of a virtual data center (VDC) including a data design center (DCD);

FIG. 2 and FIG. 2A are diagrams of a graphical user interface for creating a virtual data center;

FIG. 3 is a diagram of a graphical user interface for creating a virtual data center;

FIG. 4 is a diagram of a graphical user interface for creating a virtual data center;

FIG. 5 is a diagram of a graphical user interface for creating a virtual data center;

FIG. 6 is a diagram of a graphical user interface for creating a virtual data center;

FIG. 7 is a diagram of a graphical user interface for creating a virtual data center;

FIG. 8 is a diagram of a graphical user interface for creating a virtual data center;

FIG. 9 is a diagram of a graphical user interface for creating a virtual data center; and

FIG. 10 is a diagram of a graphical user interface for creating a virtual data center.

### DETAILED DESCRIPTION

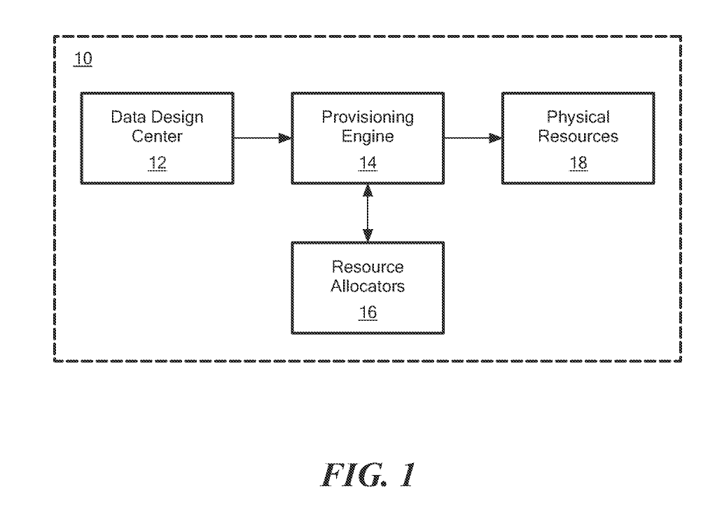

Referring now to FIG. 1, a system 10 for providing a virtual data center includes a data design center (DCD) 12 having a graphical user interface (GUI) as part thereof. In general overview, DCD 12 presents to a user a virtual whiteboard which can be used to outline, correct, improve, modify and complete, either in whole or in-part, computing infrastructure design,

DCD 12 thus eliminates the need for a user to convert hard copy network drawings for a virtual data center (VDC) into text tables of virtual servers and storage, before linking them. As is known, such prior art techniques are a cumbersome and error prone process.

DCD 12 allows a user to design a virtual data center with servers, storage, load balancers, firewalls and associated networking using a GUI. DCD 12 allows the user to add other elements to the virtual design center including, but not limited to, storage devices, internet connections, communication devices, wireless access points, cell towers, or any other type of computing devices that may be included in a computing architecture design. Once complete, a user can activate the data center design with a mouse-click. Thus, no user-generated (or user-filled) forms and/or tables are required.

As will be described in conjunction with the figures below, a user may use the DCD GUI to draw a picture of a desired virtual data center (VDC). Information related to the VDC is coupled from the GUI to a provisioning engine 14 which checks for available resources and then assigns the resources to the user. Provisioning engine 14 utilizes a database to determine which resources are available and can be assigned to the VDC in order to implement the VDC. The database has stored therein (or has access to) all details needed to build the network specified by the user through the DCD (e.g. amount of available RAM, public IP, etc.). This information is held for each user/client.

Preferably, provisioning engine 14 assigns resources in an efficient manner so as to reduce overhead. For example, provisioning engine 14 may assign servers that are co-located, so that network communication between the servers can run efficiently over a LAN. Resource allocators 16 then assign physical resources 18 (e.g. servers, storage devices, network connections, etc. . . . ) to the virtual data center.

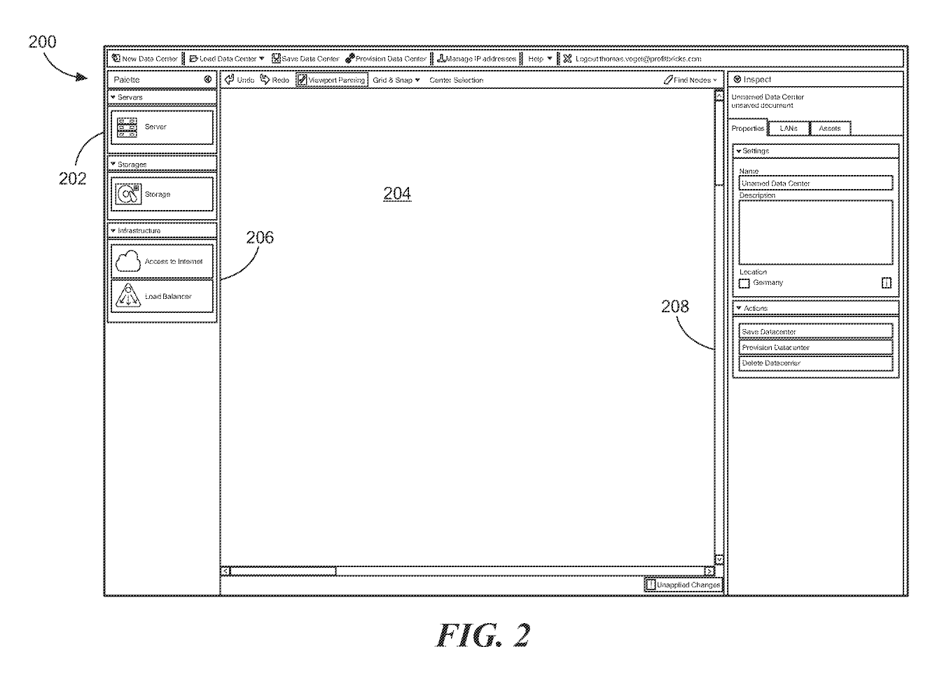

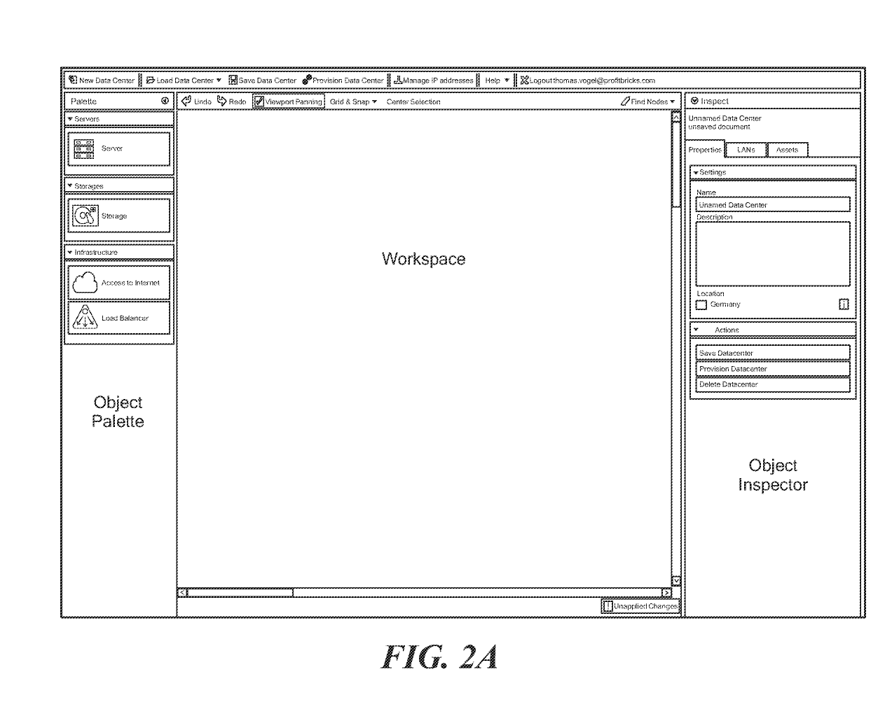

Referring now to FIG. 2, DCD GUI 200 displays a window 202 with which a user can design a virtual data center utilizing one or more network elements including, but not limited to servers, storage devices, network connections between such elements, internet connection access, load balancers, etc.

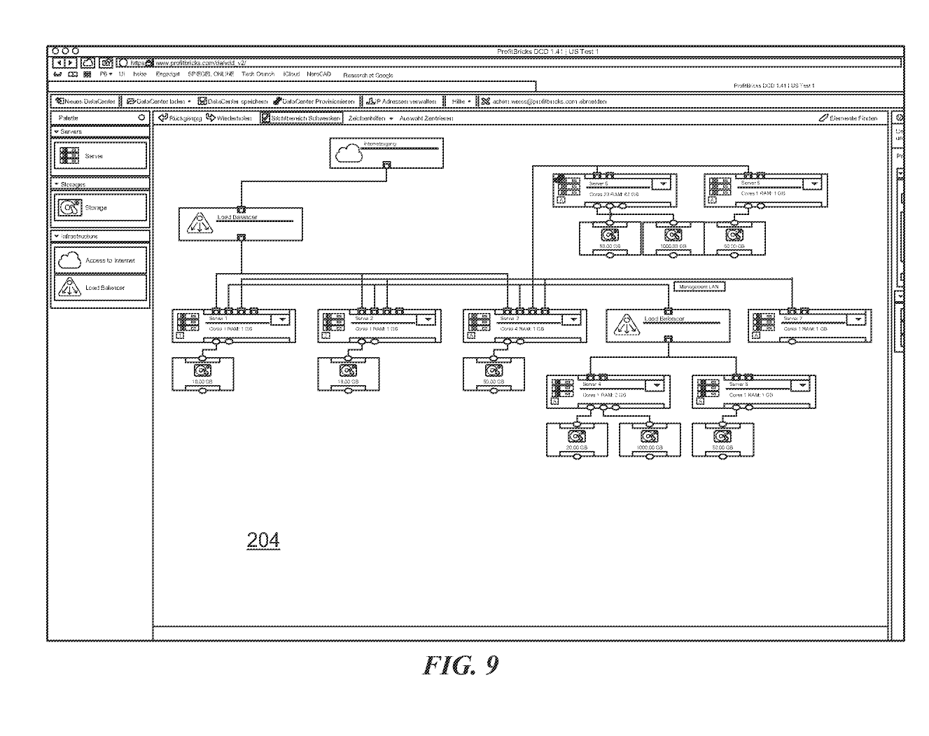

GUI 200 represents the information and actions available to a user through pictograms (e.g. icons) displayed on a display (e.g. a computer screen) and used to navigate a computer system or mobile device. Other visual indicators such a secondary notation are also used. For example, properties like position, indentation, color, symmetry, when used to convey information, are secondary notation. In one (as will be shown below in conjunction with FIG. 9) color coding of connections conveys to a user a difference between an internet connection and a network connection.

The exemplary window 202 in FIG. 2 includes three frames. A center frame 204 of the FIG. 2 window acts as a workspace (or a virtual whiteboard or design space) in which a user can drag and drop servers, storage elements, etc., in any desired configuration to design a virtual data center. Several such exemplary drag and drop and drop servers, storage elements, etc are illustrated in the left frame 206 of the FIG. 2 window. In a right frame 208 of the FIG. 2 window, a user may specify names and characteristics (or settings) of any element selected by a user for use in the workspace (i.e. the center frame of FIG. 2).

The left frame 206 may include graphical representations of computing components. As shown, the left frame 206 may include a server, a storage device, a load balancer, and an internet connection. The user may drag and drop these elements onto center frame 204 in order to design the computing infrastructure. Although not shown, the left frame 206 may include other types of computing components including, but not limited to: other types of servers, other types of storage devices, other types of network connections, firewalls, wireless network modules, mobile devices, cell towers and other types of antennas, routers and other networking components, modems such as cable modems or fiber-optic modems, etc.

The right frame 208 may allow a user to set or change settings related to the computing components in the center frame 204. These settings include the name of the server, the number of CPUs in the server, the amount of memory in the server, etc. The settings also allow a user to add a CD/DVD drive, and a network interface card (NIC), or add additional storage devices. The settings also include an availability zone setting. The availability zone setting may allow a user to specify which zone the server 802 is instantiated in. For example, a user may want to specify that servers (e.g. virtual servers) within the computing infrastructure are allocated to different physical servers so that, if one of the physical servers fails, it minimizes the chance that the entire infrastructure will fail. The user may also use the availability zone setting to specify that servers within the computing infrastructure be allocated in different data centers, or different global areas.

FIG. 2A is another illustration of the window that includes three frames. In FIG. 2A, the center frame is labeled “workspace” and may allow a user to manipulate computing elements to form a computing infrastructure. The left frame is labeled “Object Palette” and may allow a user to choose computing elements that can be added to the workspace. The right frame is labeled “Object Inspector” and may provide information about a selected computing element, and/or may allow the user to change settings related to the computing element.

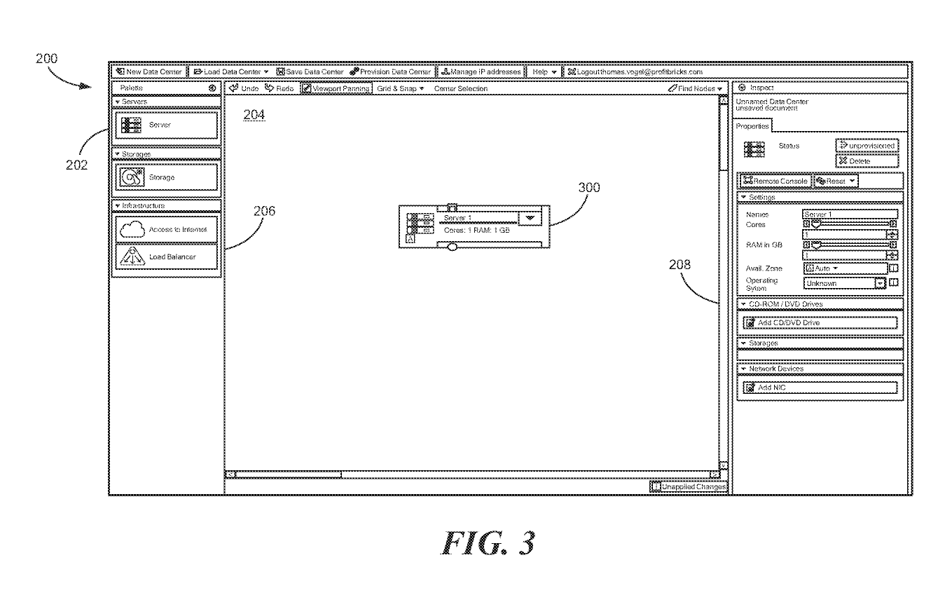

FIG. 3 is an illustration of the DCD GUI window 202 showing a server element 300 within the center frame 204. The right frame 208 shows options and settings related to the server element including name, number of CPUs, RAM, availability zone, CD/DVD drives, network devices, storage devices, etc. The user may change these settings to customize the server. Once the user chooses to implement the computer infrastructure design created in the DCD GUI window 202, the server 300 may be implemented with the settings specified in the right frame 208.

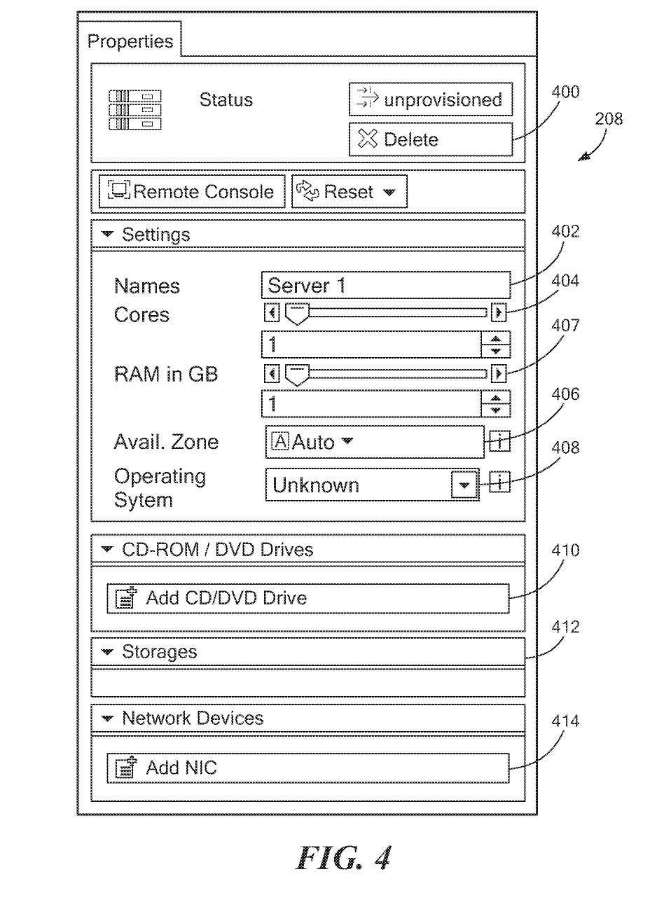

FIG. 4 is an additional view of the right panel 208 showing some of the server settings described above. The settings show a server “status” that indicates the status of the server to the user.

The user can delete the server from the center panel 204 by pressing the delete button 400. The user can specify a server name 402, the number of processor cores 404 in the server, the amount of random-access memory (RAM) 406 in the server, and the zone 406 in which the server will be implemented. As described above, the zone may specify a data center or physical location where the server is instantiated. The user can use the availability zone setting to ensure that multiple servers are located in the same area in order to facilitate communication between the servers, or specify that multiple servers are located in different areas, so as to provide redundant services in case there is a technical problem at one of the physical locations.

The user can also specify an operating system 408 to be installed on the server, one or more CD/DVD drives 410 to be installed in the server, one or more storage devices 412 (e.g. hard drives, RAID arrays, etc.) to be installed in the server, and one or more network interface cards (NIC) 414 to be installed in the computer. Although not shown in FIG. 4, the server settings may include other settings that a user can specify including, but not limited to: speed of the server, services provided by the server such as web or email services, power and energy supplies installed in the server, communication bus interfaces (e.g. serial, parallel port, I2C, USB, etc.) provided by the server, and the like.

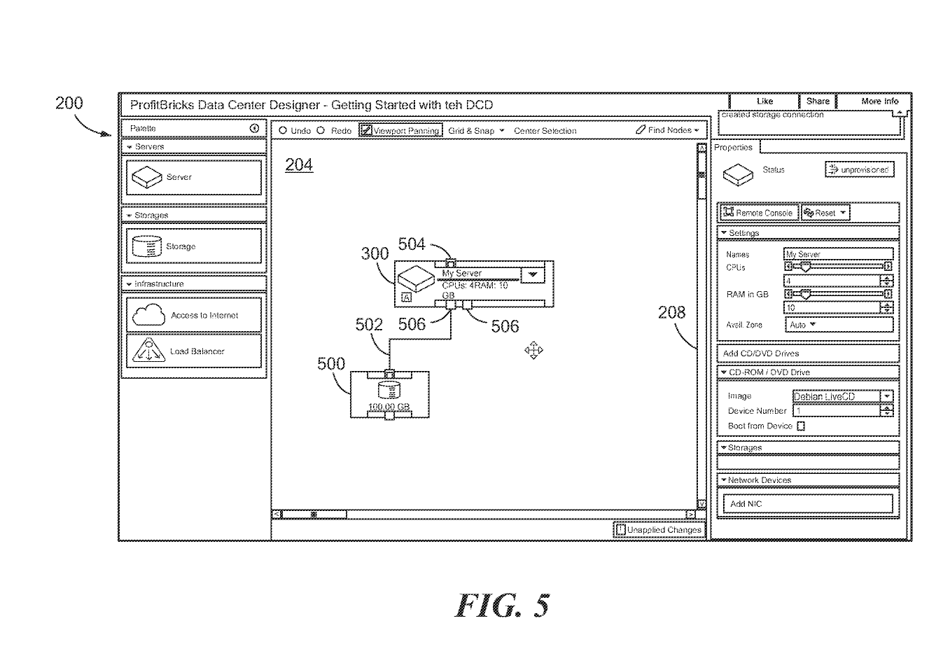

In FIG. 5, the server 300 and a storage device 500 are shown in the center panel 204. The storage device 500 may represent a hard disk, a RAID array, a flash memory, or any type of computer storage device. A user may connect the storage device 500 to the server 300 by adding a storage connection line 502 between the storage device 500 and the server 300. The line 502 may provide a communication link between the server 300 and the storage device 500. This may indicate that the server 300, when implemented in physical hardware, contains or has access to physical storage specified by the storage device 500. If desired, a user can add multiple storage devices and multiple servers to the center panel 204. The user can connect the servers and storage devices so that multiple storage devices are accessed by a single server, multiple servers access a single storage device, single servers access single storage devices, or multiple servers access multiple storage devices.

The window 200 may also allow a user to add additional computing components and connect them in various ways. For example, a user may add multiple server devices, multiple storage devices, firework, load balancers, internet connections, and any other computing component that can be included in a computing infrastructure. The user may connect the computing components together with various types of connections, such as storage connection lines, network connection lines, etc. In embodiments, computing components may have multiple connections. For example, server 802 may have multiple network connections for connection to multiple networks, and multiple storage connections for connection to multiple storage devices.

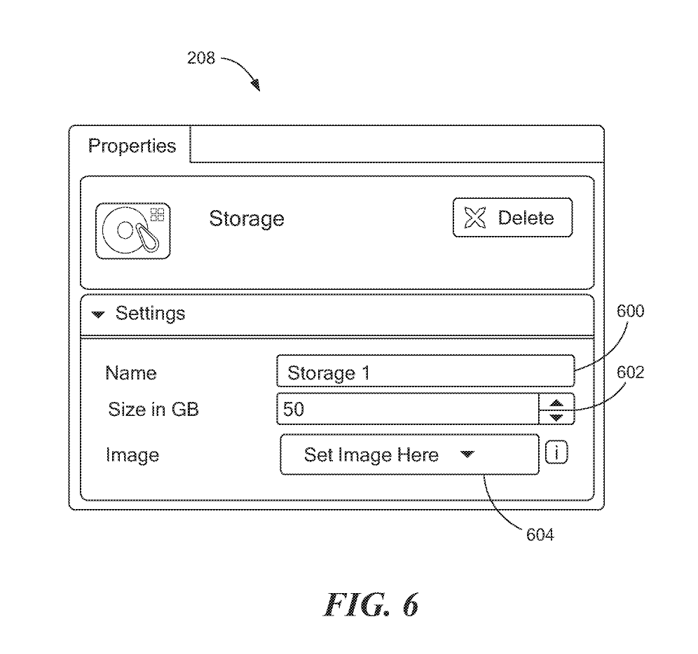

FIG. 6 shows exemplary settings related to a storage device that may be displayed in the right frame 208. The settings may include a name 600 for the storage device, a size 602 of the storage device, and an image 604 for the storage device. The disk image 604 setting may specify a predetermined disk image to be loaded on the storage device. A user may be able to set these settings by typing in a name or a size for the storage device, or by selecting an image for the storage device from a drop-down box. However, the GUI may include other methods that the user can use to change settings for the storage device as well.

The image for the storage device may be a disk image and/or an operating system that is to be installed on the storage device once the storage device is allocated in physical hardware. Choices for the image may include a Windows® image, and Linux™ image, a MAC™ image, a blank image, or any other type of disk image. In an embodiment, the user may also be able to set whether the storage device is a bootable storage device. In such an embodiment, the image may be a bootable disk image, and may include one or more operating systems into which a server can boot.

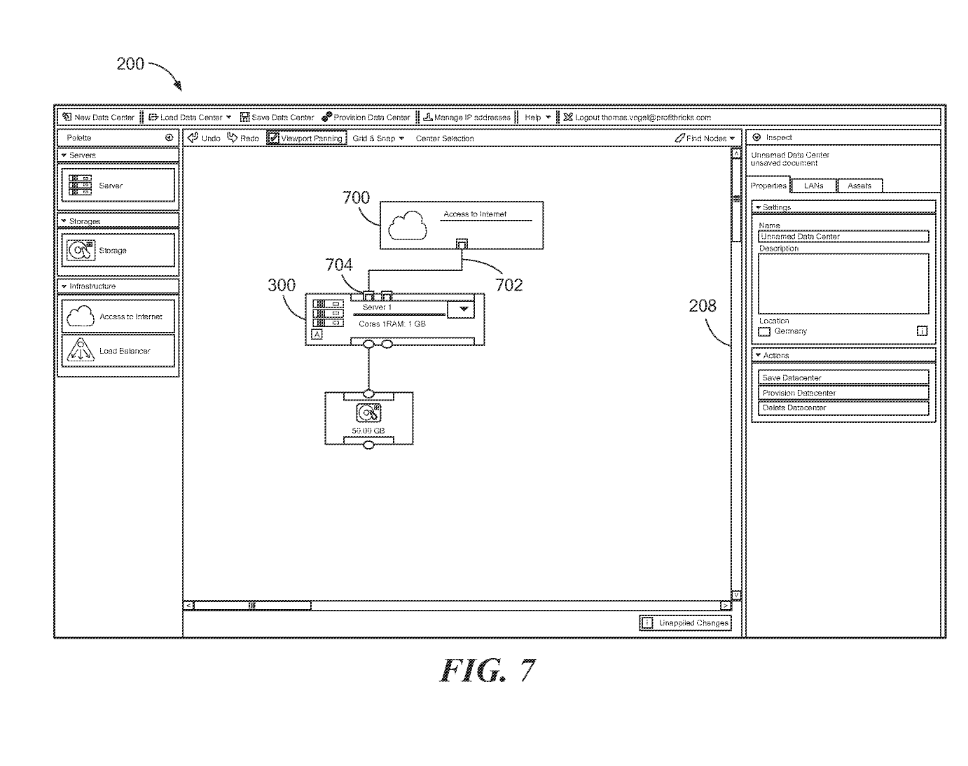

FIG. 7 shows another view of the window 200. As shown, a network connection 700 has been added to the computing infrastructure. A network connector line 702 connects the network connection 700 and the server 300. In an embodiment, the network connector line 702 may connect the network connection 700 to a NIC card 704 in the server 300. In an embodiment, the network connection 700 may be an internet connection that provides the server 300 (or any other computing devices) with access to the internet. In other embodiments, the network connection 700 may be a connection to a LAN, a WAN, or any other type of network.

Although not shown, the window 200 may also include settings in the right frame 208 that a user can set for the network connection 700. These settings may include network bandwidth, number of parallel network/internet connections, type of internet connection (e.g. cable, fiber), etc.

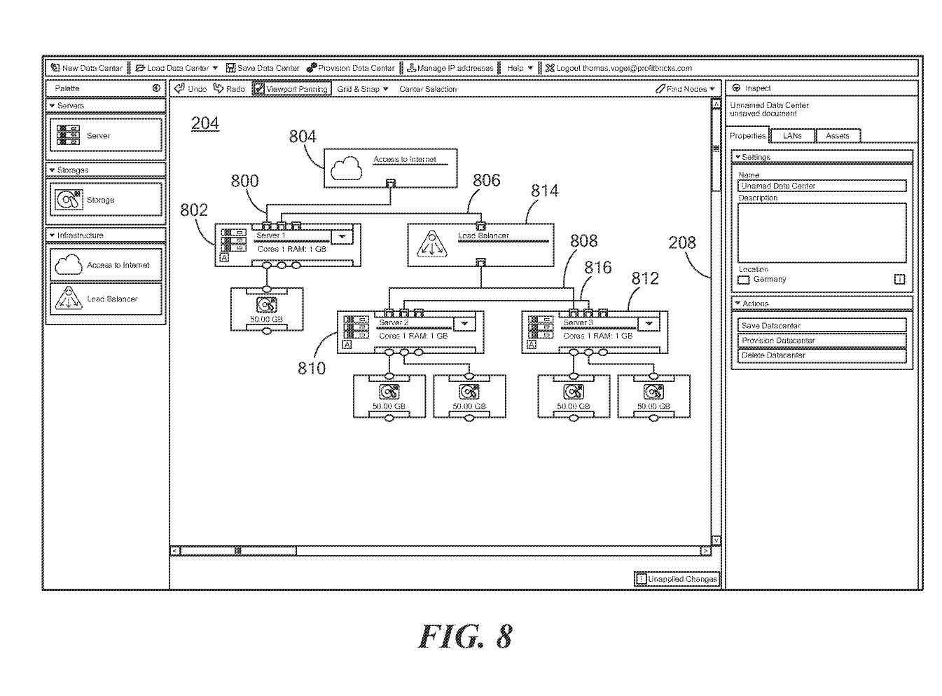

FIG. 8 and FIG. 9 show the window 200 with relatively more complex computer infrastructure designs displayed within the center panel 204 In FIG. 8A the computing infrastructure includes servers, storage devices, and a network connection, but also includes additional networks. For example, there is one network (indicated by line 800) between server 802 and the internet connection 804. There is also another network (indicated by line 806 and 808) running between server 802, server 810, server 812, and a load balancer 814. A third network (indicated by tine 816) is shown between server 810 and server 812. In an embodiment, the lines representing these different networks may be shown in different colors so a user can easily identify, design, and manipulate the network connections. FIG. 9 illustrates another example of a computer infrastructure design displayed within the center panel 204. As shown, the computer infrastructure in FIG. 9 includes internet connections, load balancers, servers, and storage devices. Although not shown, a user may create a computer infrastructure design that includes other elements, including, but not limited to:

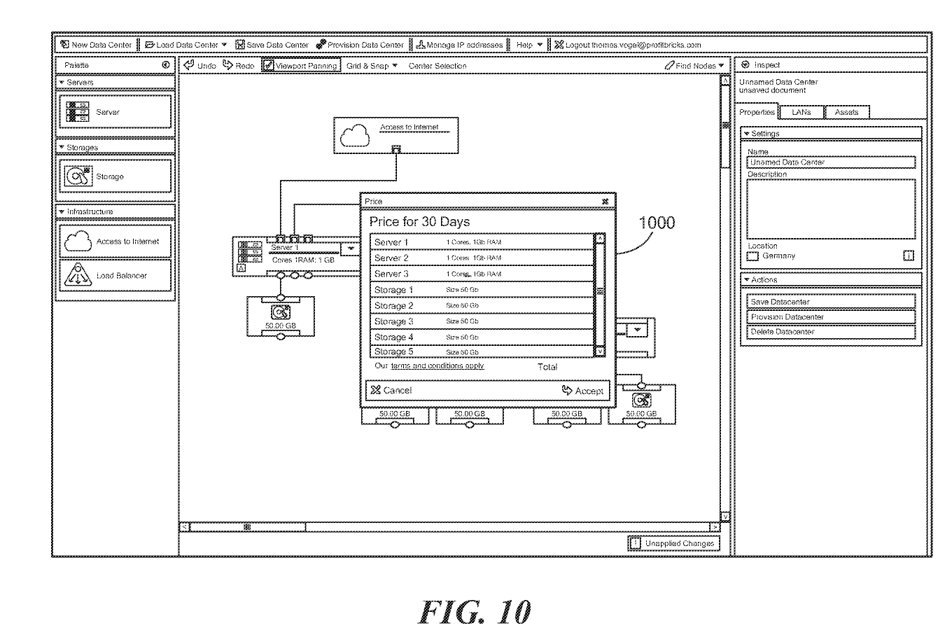

FIG. 10 shows an implementation dialog box 1000 that may allow a user to implement the computing infrastructure design. In an embodiment, the user may design the computing infrastructure via the DCD GUI, then use the implementation dialog box 1000 to initiate implementation of the computing infrastructure with physical computing resources. The implementation dialog box may include pricing information, time durations, legal terms and conditions, one or more buttons that allow the user to accept the design, etc.

Referring again to FIG. 1, once the computing infrastructure has been designed in the data design center using the GUI, the provisioning engine may provision resources to implement the computing infrastructure. In an embodiment, the provisioning engine may access a database that contains information about what physical resources are available to implement the computing infrastructure. The database may contain information about what physical resources (e.g. servers, storage devices, datacenters, network connections, etc) exist within physical data centers. The database may also contain information about the load on the physical resources, and how much of the physical resource is “free” and can be used to implement the computing infrastructure.

Once any free physical resources are identified, the resource allocators may allocate appropriate physical resources from one or more physical data centers. The allocated physical resources may include servers, portions of servers, storage devices, portions of storage devices, network interfaces, portions of network interfaces, firewalls, load balancers, etc. Once the resources are allocated to the computing infrastructure, the resource allocators and/or the provisioning engine may update the database to reflect which physical resources, or portions thereof, have been allocated to the computing infrastructure.

Users can also make changes to the computing infrastructure after it has been implemented. A user may, for example, use the DCD GUI to modify the presently-implemented. design, and/or to change the various settings associated with computing devices within the design, then issue a command to implement the new design. The provisioning engine and/or resource allocators may then release, acquire, or re-arrange additional computing resources to implement the changes made by the user.

In an embodiment, the provisioning engine and/or resource allocators may re-allocate physical resources that are being used to implement the computing infrastructure. For example, if a physical server becomes overloaded, it may be advantageous to use a different server that has less of a load to implement the computing infrastructure. In such an instance, the provisioning engine and/or resource allocators may re-allocate the computing infrastructure to the server having less of a load. The re-allocation process may be transparent to end users of the computing infrastructure.

If a server is specified in the computing infrastructure, the system may create a virtual server that implements the specified server. The virtual server may be a software construct that may be connected to (i.e. can access) physical servers that implement the virtual server. The physical servers that implement the virtual server may be multiple physical servers, portions of physical servers, a single physical server, or combinations thereof.

If a storage device is specified in the computing infrastructure, the provisioning engine and/or resource allocators may create a disk volume on one or more physical storage servers that implements the specified storage device. An interconnection between the disk volume and a virtual server may be made so that the virtual server can access the specified storage.

The provisioning engine and/or resource allocations may also make any network connections or storage connections between the physical resources that are necessary to implement the computing infrastructure.

Once the physical resources have been allocated (e.g. reserved), a virtual machine representing the computing infrastructure may be implemented. The virtual machine may be a virtual representation of the computing infrastructure. The virtual machine may be connected to (e.g. able to access) the physical resources that have been allocated to the computing infrastructure.

In an embodiment, a physical server bank (i.e. a group of servers) may be divided into a number of virtual servers. Physical server banks may provide physical resources that can be allocated to computing infrastructures. The physical server bank may be divided into a number of virtual servers, where each virtual server uses a portion of the physical resources provided by the physical server bank. In other embodiments, a single physical server may be divided into multiple virtual servers in a similar manner.

Having described preferred embodiments of the invention it will now become apparent to those of ordinary skill in the art that other embodiments incorporating these concepts may be used. Accordingly, it is submitted that the invention should not be limited to the described embodiments but rather should be limited only by the spirit and scope of the appended claims.

The systems and methods described herein may be implemented hardware, software, or a combination. Software may comprise software instructions stored on one or more computer readable medium which, when executed by one or more processors, cause the processors to perform operations that implement the systems and methods.

1. A method for designing, correcting and improving a Virtual Data Center (VDC) using a Data Center Designer (DCD), the method comprising:
providing a graphical user interface module that allows a user to graphically design a computing infrastructure having specified functionality;
receiving, by a computing system, a design for the computing infrastructure from the graphical user interface module;
allocating, by the computing system, computing resources in one or more physical data centers for implementing the specified functionality; and
providing access to computing services that implement the specified functionality by utilizing the allocated computing resources.

2. The method of claim 1 further comprising dynamically re-allocating the computing resources as the computing services are provided.

3. The method of claim 1 wherein the user interface includes features to allow a user to specify one or more servers.

4. The method of claim 1 wherein the user interface includes features to allow a user to specify one or more storage devices.

5. The method of claim 1 wherein the user interface includes features to allow a user to specify one or more network connections.

6. The method of claim 1 wherein the user interface includes features to allow a user to specify one or more connections to an internet.

7. The method of claim 1 wherein the user interface includes features to allow a user to specify one or more load balancers.

8. The method of claim 1 wherein the user interface includes features to allow a user to specify an operating system.

9. A Data Center Designer (DCD) system for use with a Virtual Data Center (VDC), the system comprising:
a graphical user interface configured module that allows a user to graphically design a computing infrastructure having specified functionality;
one or more physical computing centers having computing resources capable of providing the specified functionality; and
a computer service interface configured to:
allocate at least a portion of the computing resources from the physical computing centers in order to implement the specified functionality; and
provide an interface for utilizing the specified functionality.

10. The DCD system of claim 9 wherein the computer service interface is configured to dynamically allocate the computing resources.

11. The DCD system of claim 9 wherein the user interface includes features to allow a user to specify one or more servers.

12. The DCD system of claim 9 wherein the user interface includes features to allow a user to specify one or more storage devices.

13. The DCD system of claim 9 wherein the user interface includes features to allow a user to specify one or more network connections.

14. The DCD system of claim 9 wherein the user interface includes features to allow a user to specify one or more connections to an internet.

15. The DCD system of claim 9 wherein the user interface includes features to allow a user to specify one or more load balancers.

16. The DCD system of claim 9 wherein the user interface includes features to allow a user to specify an operating system.

17. The DCD system of claim 9 wherein the physical computing centers are located in a same location, located in different locations, or a combination thereof.

18. The DCD system of claim 9 wherein the allocated computing resources comprise a computing infrastructure, different from the graphically designed computing infrastructure, for providing the same specified functionality.

19. The DCD system of claim 9 wherein the computer service interface provides the specified functionality as a service.

20. The DCD system of claim 19 wherein the graphical user interface includes a feature that allows a user to purchase the service.
